(19) United States
(12) Patent Application Publication
(10) Pub. No.: US 2016/0314721 A1
(43) Pub. Date: Oct. 27, 2016

(54) ANTI-TAMPER LABEL AND STORAGE DEVICE WITH THE SAME

(71) Applicant: KABUSHIKI KAISHA TOSHIBA, Tokyo (JP)

(72) Inventors: Hisashi HASEGAWA, Yokohama Kanagawa (JP); Kenichi NUMATA, Akishima Tokyo (JP); Kentaro UMESAWA, Kawasaki Kanagawa (JP)

(21) Appl. No.: 14/949,532

(22) Filed: Nov. 23, 2015

Related U.S. Application Data
(60) Provisional application No. 62/152,238, filed on Apr. 24, 2015.

(51) Int. Cl. G09F 3/02; G06F 1/18

(52) U.S. Cl. CPC G09F 3/02; G06F 1/182; G09F 2003/0257; G09F 3/10

(57) ABSTRACT

A storage device includes a housing accommodating a storage medium; a printed circuit board having a first side on which electronic components of the storage device are mounted and a second side opposite to the first side, a label overlying the second side of the printed circuit board, the label comprising a base layer and a metal film formed on a surface of the base layer, the metal film being attached to the second side of the printed circuit board, and an insulating layer between the second side of the printed circuit board and a portion of the label.

### CROSS-REFERENCE TO RELATED APPLICATIONS

This application is based upon and claims the benefit of priority from U.S. Provisional Application No. 62/152,238, filed on Apr. 24, 2015, the entire contents of which are incorporated herein by reference.

### FIELD

Embodiments described herein relate generally to an anti-tamper label and a storage device with the same.

### BACKGROUND

For storage devices such as hard disk drives (HDDs) and solid-state drives (SSDs), it is desirable to detect the theft or possible falsification of stored data from physical tampering. Therefore, an anti-tamper label may be attached to a storage device. For example, an anti-tamper label may be attached to an outer surface of a printed circuit board of an HDD.

The anti-tamper label leaves a special adhesive on a member to which the label is attached if the label is detached from the member, thereby leaving a trace of physical tampering. Because a surface of an ordinary printed circuit board has exposed thereon conductive portions such as vias, test pads and the like, the anti-tamper label attached to the printed circuit board is made of a non-conductive material, that is, an insulator. However, under specific environmental conditions, such as high temperature or high humidity, the special adhesive may not bond too well with the printed circuit board so that the trace of physical tampering may not remain on the printed circuit board even though physical tampering has occurred.

Further, there are anti-tamper labels containing metal, such as when aluminum is vapor-deposited on the label base material. Such anti-tamper labels adhere more strongly to the printed circuit board and thus are more difficult to remove than insulator-based anti-tamper labels without leaving a trace. As a result, the anti-tamper label of this type can reliably leave a trace of tampering even under high temperature or high humidity conditions. However, since the vapor-deposited metal label is conductive, it may cause a short circuit when it is attached directly to the printed circuit board.

### BRIEF DESCRIPTION OF THE DRAWINGS

FIG. 1 is a perspective view showing a top cover side of a hard disk drive (HDD) in which an anti-tamper label of a first embodiment may be implemented.

FIG. 2 is a perspective view showing a bottom surface side of the HDD.

FIG. 3 is an exploded perspective view of the HDD.

FIG. 4 is an exploded perspective view showing a housing of the HDD and the anti-tamper label of the first embodiment.

FIG. 5 is a plan view of a bottom surface (back surface) of the HDD before the anti-tamper label is attached thereto.

FIG. 6 is a plan view of the bottom surface of the HDD in a state where an insulating sheet is attached thereto.

FIG. 7 is a plan view of the bottom surface of the HDD in a state where the anti-tamper label is attached thereto.

FIGS. 8A and 8B are plan views of the anti-tamper label before use and the anti-tamper label after use, respectively.

FIG. 9 is a plan view of the HDD in a state where the anti-tamper label is partly removed.

FIG. 10 is a plan view of the HDD in a state where the anti-tamper label is completely removed.

FIG. 11 is a plan view of the HDD in a state where an insulating label and the anti-tamper label are partly removed at the same time.

FIG. 12 is another plan view of the HDD in a state where the insulating label and the anti-tamper label are partly removed at different places.

FIG. 13 is a perspective view of the anti-tamper label with the insulating label attached thereto.

FIG. 14 is a plan view of an HDD having an anti-tamper label according to a second embodiment, where an insulating coating agent is applied to a printed circuit board.

FIG. 15 is a plan view of an anti-tamper label according to a third embodiment, where an insulating coating agent is applied thereto.

FIG. 16 is a plan view of an anti-tamper label according to a fourth embodiment.

FIG. 17 is a plan view of an anti-tamper label according to a fifth embodiment.

FIG. 18 is a perspective view showing a back surface side of a HDD to which the anti-tamper label of the fifth embodiment is attached.

FIG. 19 is a perspective view showing a top cover side of the HDD to which the anti-tamper label of the fifth embodiment is attached.

### DETAILED DESCRIPTION

Various embodiments will be described hereinafter with reference to the accompanying drawings. In general, according to one embodiment, a storage device comprises a printed circuit board having a first side on which electronic components of the storage device are mounted and a second side opposite to the first side, a label overlying the second side of the printed circuit board, the label comprising a base layer and a metal film formed on a surface of the base layer, the metal film being attached to the second side of the printed circuit board, and an insulating layer between the second side of the printed circuit board and a portion of the label.

### First Embodiment

Now, as the storage device, a hard disk drive (HDD) of a first embodiment will be described.

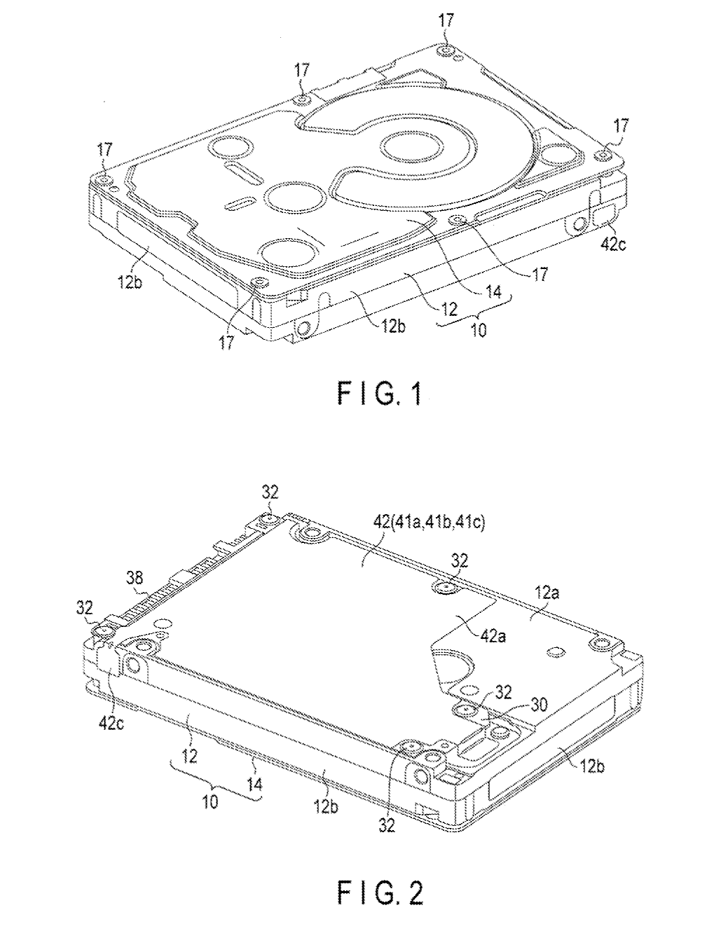

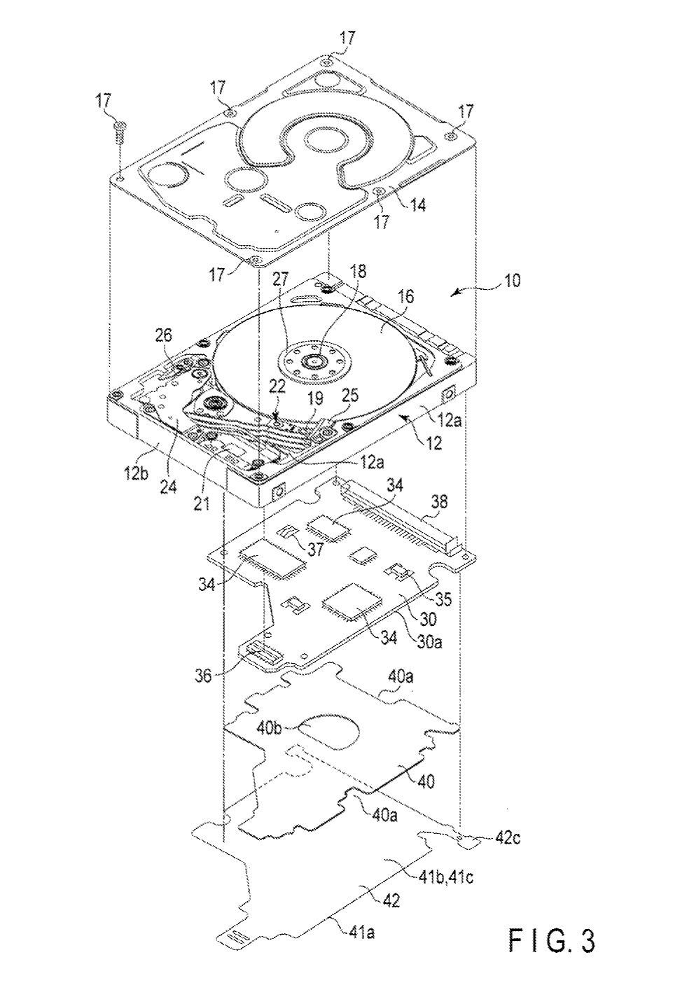

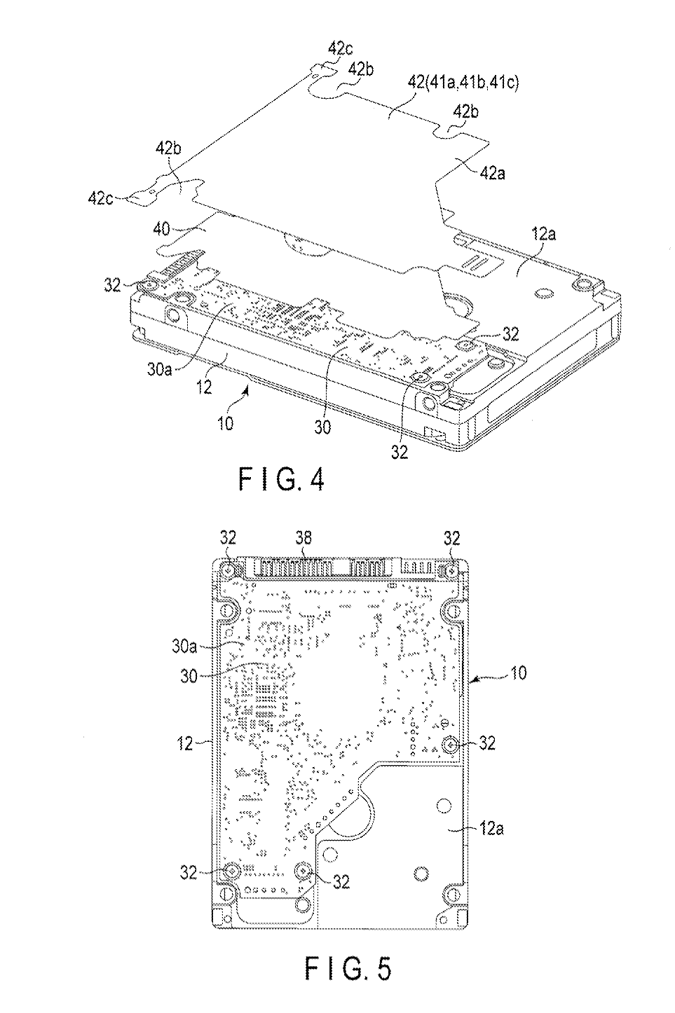

FIG. 1 is a perspective view showing a top surface side of the HDD, FIG. 2 is a perspective view showing the bottom surface (back surface) side of the HDD, FIG. 3 is an exploded perspective view showing the internal structure of the HDD in a state where a top cover is removed, and FIG. 4 is an exploded perspective view showing a housing of the HDD, an insulating sheet and an anti-tamper label.

As shown in FIGS. 1 to 4, the HDD comprises a housing 10. The housing 10 comprises a base 12 in a shape of a rectangular box with an opening on the upper surface, and a top cover 14 fixed to the base 12 by a plurality of screws 17 and closing the upper end opening of the base 12. The base 12 comprises a rectangular bottom wall 12a and sidewalls 12b standing along the peripheral edge of the bottom wall 12a.

The rectangular plate-shaped top cover 14 is formed, for example, by pressing an aluminum alloy plate to a thickness of about 0.4 mm. The top cover 14 comprises through-holes provided respectively at the four corners and substantially in the middles of the side edges of a pair of long sides. The top cover 14 is fixed to the base 12 by screwing into screw holes, formed at the sidewalls 12b of base 12, the screws 17 threaded into the respective through-holes, thereby closing the upper end opening of the base 12.

In the housing 10, for example, four magnetic disks 16 as storage media and a spindle motor as a driver configured to support and rotate the magnetic disks 16 are provided. The spindle motor 18 is provided on the bottom wall 12a. Each magnetic disk 16 has a diameter of, for example, 65 mm (2.5 inches) and comprises a magnetic storage layer on one surface (upper surface) and the other surface (lower surface), respectively. The magnetic disks 16 are coaxially engaged with a hub (not shown) of the spindle motor 18, clamped to the hub by a clump spring 27 and secured to the hub. In this way, the magnetic disks 16 are supported in parallel with the bottom wall 12a of the base 12. The magnetic disks 16 are then rotated by the spindle motor 18 at a particular speed.

In the housing 10, a plurality of magnetic heads 19 configured to write and read data to and from the magnetic disks 16, and a carriage assembly 22 configured to support these magnetic heads 19 in a movable manner with respect to the magnetic disks 16 are further provided. In the housing 10 are further provided a voice coil motor (VCM) 24 configured to rotate the carriage assembly 22 and position the magnetic heads 19, a ramp load mechanism 25 configured to hold the magnetic heads 19 at an unloading position away from the magnetic disks 16 when the magnetic heads 19 are moved to the outermost periphery of the magnetic disks 16, a latch mechanism 26 configured to hold the carriage assembly 22 at a retreat position when a shock or the like acts on the HDD, and a flexible printed circuit (FPC) unit 21 mounted with an electronic component such as a conversion connector.

As shown in FIGS. 2 to 5, a printed circuit board (control circuit board) 30 is fixed to the outer surface (bottom surface) of the bottom wall 12a of the base 12 by a plurality of screws 32 and faces the bottom wall 12a of the base 12 with a small gap therebetween. Between the outer surface of the bottom wall 12a of the base 12 and the printed circuit board 30, an insulating sheet (or insulating film) (not shown) as an insulating member is provided.

On the inner surface (surface facing the base 12) of the printed circuit board 30, a plurality of semiconductor elements 34, e.g., semiconductor chips including a controller, and electronic components such as a rotational vibration sensor (or acceleration sensor) 35 and the like are mounted. A connector 36 is provided at one longitudinal end side of the printed circuit board 30, and an interface connector 38 connectable to an external device is provided at the other longitudinal end side of the printed circuit board 30. In the longitudinal center of the printed circuit board 30, a connection terminal 37 for the spindle motor 18 is provided.

In a state where the printed circuit board 30 is attached to the base 12, the connector 36 is connected to the conversion connector of the FPC unit 21. Further, the connection terminal 37 is connected to the connection terminal which connects to the spindle motor 15. The controller of the printed circuit board 30 is configured to control operations of the VCM 24 and the magnetic heads 19 via the FPC unit 21 and operation of the spindle motor 18 via the connection terminal 37.

As shown in FIGS. 4 and 5, the back surface (surface opposite to the surface facing the base 12) 30a of the printed circuit board 30 is flat and substantially flush with the bottom surface of the bottom wall 12a of the base 12. On the back surface 30a of the printed circuit board 30, some of the conductive portions such as connection pads, test pads, and vias are exposed.

As shown in FIGS. 2 to 4, a sheet-shaped insulating label 40 and an anti-tamper label 42 are superimposed and attached to the back surface 30a of the printed circuit board 30 to cover substantially the entire surface of the back surface 30a. The back surface 30a provides an attached surface to which the anti-tamper label 42 is to be attached. The insulating label 40 is made of a polyester material such as polyethylene terephthalate (PET), polycarbonate or the like and formed into a sheet or a film. The insulating label 40 has a thickness of, for example, about 0.05 to 0.1 mm, but the thickness may be determined in consideration of the strength or the cost of a material of the insulating label 40.

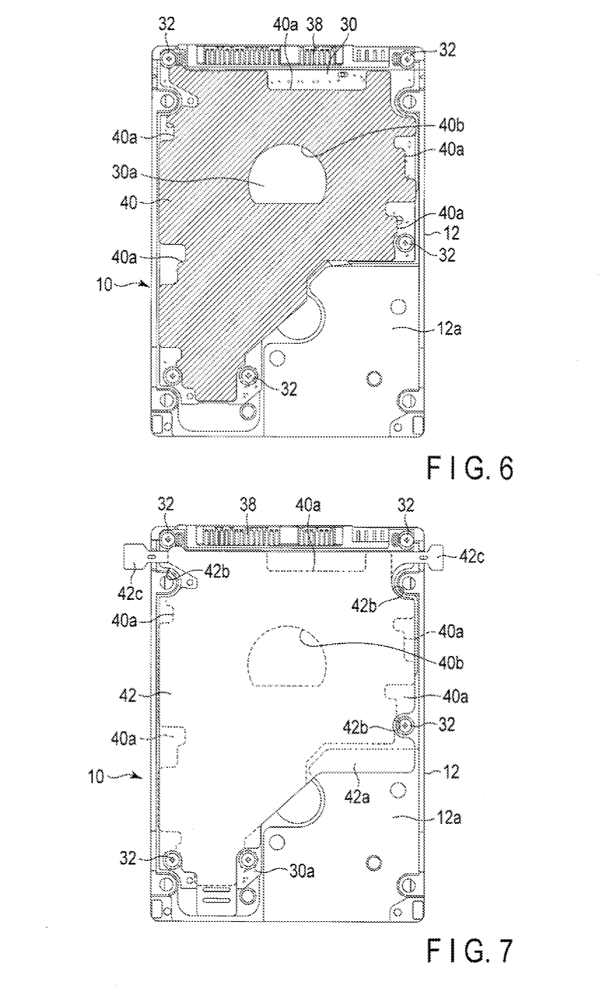

As shown in FIG. 6, the insulating label 40 is formed in a shape substantially the same as that of the printed circuit board 30 and to have a size slightly smaller than that of the back surface 30a of the printed circuit board 30. In the present embodiment, the insulating label 40 comprises a plurality of notches (recessed portions) 40a formed at the side edges and an opening 40b formed near the center. The notches 40a and the opening 40b function as uncovered portions exposing the printed circuit board 30 without covering it. The insulating label 40 is attached to the back surface 30a of the printed circuit board 30 with an insulating adhesive and covers most part of the back surface 30a. In portions facing the notches 40a and the opening 40b, the back surface 30a of the printed circuit board 30 is exposed without being covered with the insulating label 40. Note that the notches 40a and the opening 40b of the insulating label 40 are provided at locations on the back surface 30a of the printed circuit board 30 where there is no risk of a short circuit, such as for example, portions in which conductive portions such as test pads and vias are not exposed, and portions at which a short circuit will not be problematic, such as vias or test pads for a ground signal.

As shown in FIGS. 2, 4 and 7, the anti-tamper label 42 is formed in a shape substantially the same as that of the printed circuit board 30 and to have a size greater than that of the insulating label 40. Further, at least a part of the anti-tamper label 42 is formed to have a size greater than that of the back surface 30a of the printed circuit board 30.

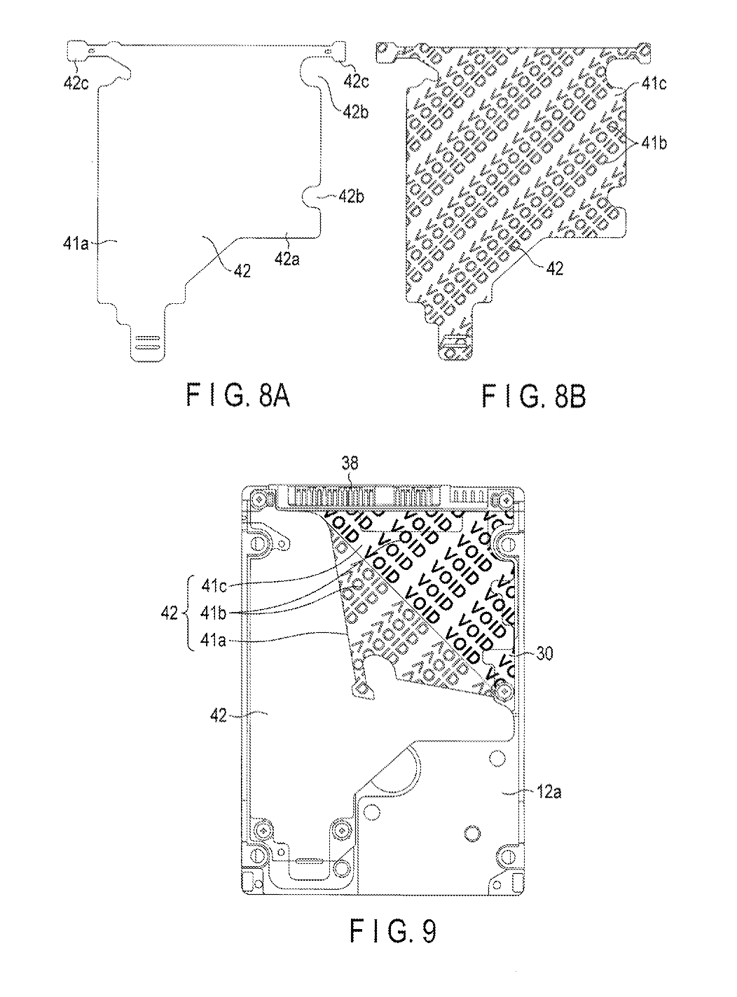

The anti-tamper label 42 comprises a sheet-shaped base material 41a made of a plastic film or the like, a vapor-deposited metal film 41b formed by vapor-depositing metal such as aluminum on a surface of the base material 41a, and an adhesive surface or adhesive layer 41c formed on a surface of the vapor-deposited metal film 41b. As shown in FIGS. 8A and 8B, when the attached anti-tamper label 42 is removed, a text such as “opened” or “void” or a symbol appears on the surface of the label base material 41a. At the same time, a text such as “opened” or “void” or a symbol made from the vapor-deposited metal film 41b or a special adhesive remains on a surface (here, the back surface 30a of the printed circuit board 30) to which the label was attached. In this way, the anti-tamper label 42 can leave a trace of physical tampering. Further, the anti-tamper label 42 comprising the vapor-deposited metal film 41b can leave the trace clearly even when removed under a specific environmental condition of temperature or humidity.

As shown in FIG. 7, the anti-tamper label 42 is superimposed on the insulating label 40 and attached to the back surface 30a of the printed circuit board 30 by the adhesive layer 41c to cover substantially the entire surface of the back surface 30a. Note that a side of the anti-tamper label 42 attached to the printed circuit board 30 is the vapor-deposited metal film 41b side. The portions of the anti-tamper label 42 facing the notches 40a and the opening 40b of the insulating label 40 are attached directly on the back surface 30a of the printed circuit board 30. Further, a portion 42a of the anti-tamper label 42 overlaps with the bottom wall 12a and is attached to the bottom wall 12a.

The side edges of the anti-tamper label 42 comprise three arc-shaped notches (recessed portions) 42b, and these notches are located in proximity to fixation screws 32 of the printed circuit board 30 or to screw holes for fixing the housing 10 to another device. The anti-tamper label 42 comprises a pair of extension portions 42c protruding on both sides from the end of the connector 38 side. These extension portions 42c are extending beyond the side edges of the printed circuit board 30 and attached to the side walls of the base 12.

According to the HDD comprising the above-described structure, it is possible to use the anti-tamper label 42 for the printed circuit board 30 while maintaining its tamper resistance characteristics by providing the sheet-shaped insulating member (insulating label) 40 comprising the notches 40a and the opening 40b between the printed circuit board 30 and the metal-containing conductive anti-tamper label 42. That is, the anti-tamper label 42 comprising a vapor-deposited metal film can be used without causing a short circuit of the printed circuit board 30.

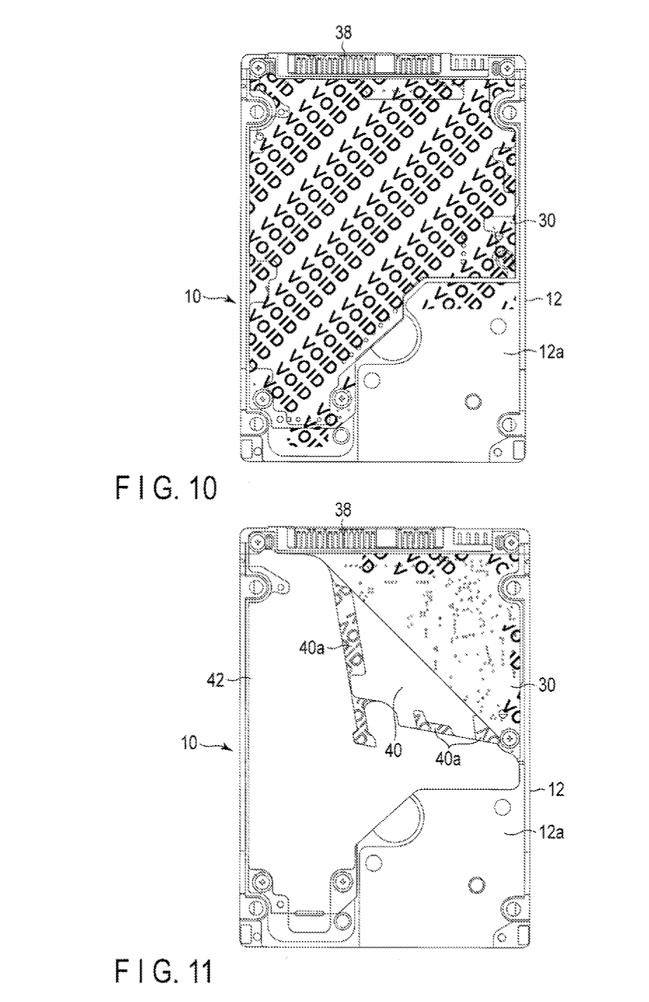

As shown in FIGS. 9 and 10, when the once attached anti-tamper label 42 is removed, a text such as “void” appears on the surface base material of the label, and thus the anti-tamper label 42 can leave a trace of physical tampering on the printed circuit board 30 and the insulating label 40. Here, by using the anti-tamper label 42 comprising a vapor-deposited metal film, the anti-tamper label 42 can leave a trace clearly even when removed under a high temperature condition. Further, since the portion 42a of the anti-tamper label 42 is attached to the bottom wall 12a of the base 12, the anti-tamper label 42 when removed leaves a trace also on the housing 10 as shown in FIG. 10. In this way, it becomes possible to detect the theft or possible falsification of stored data by physical tampering with the HDD.

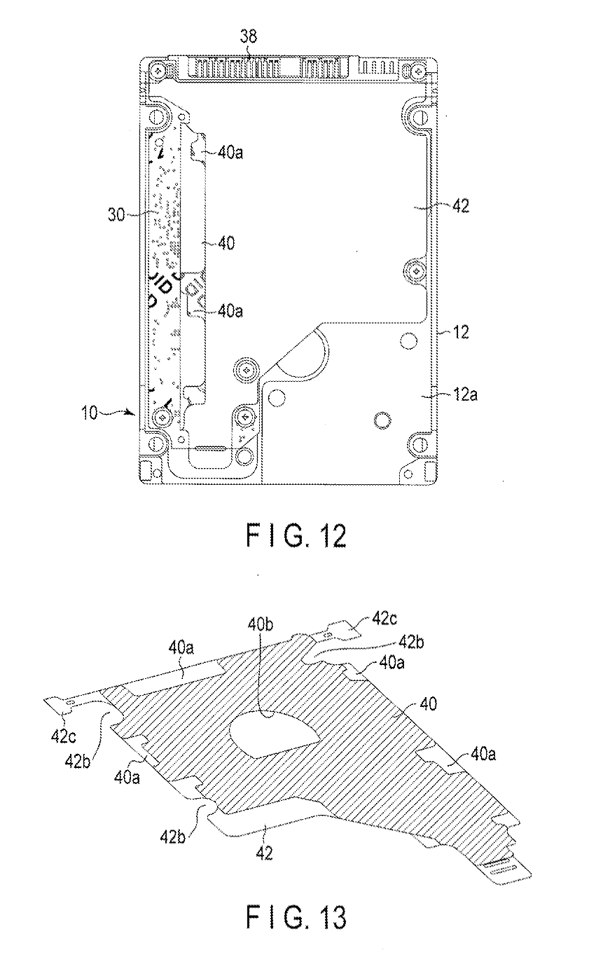

Further, in the portions corresponding to the notches 40a provided in the insulating label 40, the anti-tamper label 42 is directly attached on the printed circuit board 30. Therefore, as shown in FIGS. 11 and 12, even in a case where the anti-tamper label 42 and the insulating label 40 are removed together with or a case where the side edge of the anti-tamper label 42 is partly stripped off, a trace is left on the printed circuit board 30.

From the above, it is possible to use the metal-containing conductive anti-tamper label 42 for the printed circuit board 30 while maintaining its tamper resistance characteristics, and thus an HDD having improved reliability in detecting the theft or possible falsification of stored data by physical tampering can be obtained. Since it is no longer essential for the anti-tamper label to be an insulator, it becomes possible to select a material from greater options and also to use a more inexpensive material.

Note that the sheet-shaped insulator, namely, the insulating label 40 may use a plastic (resin) film such as a PET film alone or a label material formed of a plastic film with an adhesive added thereto. The anti-tamper label 42 and the insulating label 40 may be attached separately on the printed circuit board or may be attached together in advance as shown in FIG. 13.

Next, HDDs and anti-tamper labels of other embodiments will be described. In the following descriptions of the other embodiments, the components the same as those in the above-described first embodiment are denoted by the same reference numbers and detailed descriptions thereof are omitted, and the components different from those in the first embodiment are mainly described.

### Second Embodiment

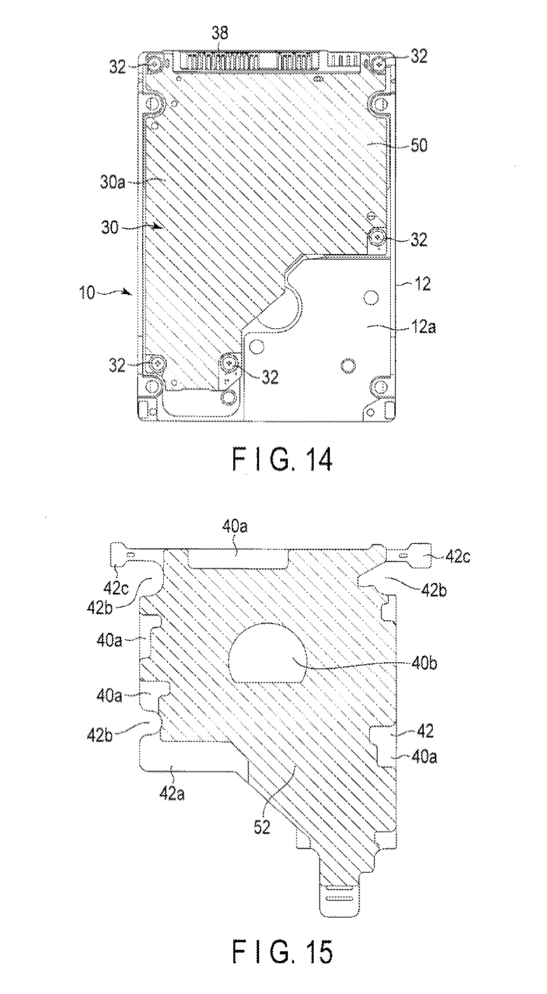

As shown in FIG. 14, instead of the sheet-shaped insulator, an insulating coating agent may be applied to the attached surface to which the label is attached, here, to the back surface 30a of the printed circuit board 30. The insulating coating agent made from acrylic resin, polyurethane resin, or polyolefin resin is applied in advance to the printed circuit board 30, thereby forming an insulating layer 50 on the back surface 30a. Further, to the insulating layer 50, the above-described anti-tamper label 42 is attached. In this way, the metal-containing conductive anti-tamper label 42 can be used for the printed circuit board 30. Note that the insulating layer 50 formed of the coating will not come off easily from the printed circuit board 30. Therefore, when the anti-tamper label 42 is removed, the insulating layer 50 will not come off at the same time, and the anti-tamper label 42 can leave a trace reliably on the printed circuit board 30.

### Third Embodiment

FIG. 15 shows an anti-tamper label of an HDD of the third embodiment. As shown in the drawing, an insulating coating agent instead of a sheet-shaped insulator may be applied to an adhesive surface (adhesive layer) of the anti-tamper label 42.

In a portion of the adhesive surface 41c of the anti-tamper label 42 which needs to be insulated from the printed circuit board 30, an insulating coating agent made of acrylic resin, polyurethane resin, or polyolefin resin is applied to form an insulating layer 52. The anti-tamper label 42 is attached to the printed circuit board 30 in such a manner that the insulating layer 52 faces the back surface 30a of the printed circuit board 30. In this way, the metal-containing conductive anti-tamper label 42 can be used for the printed circuit board 30.

### Fourth Embodiment

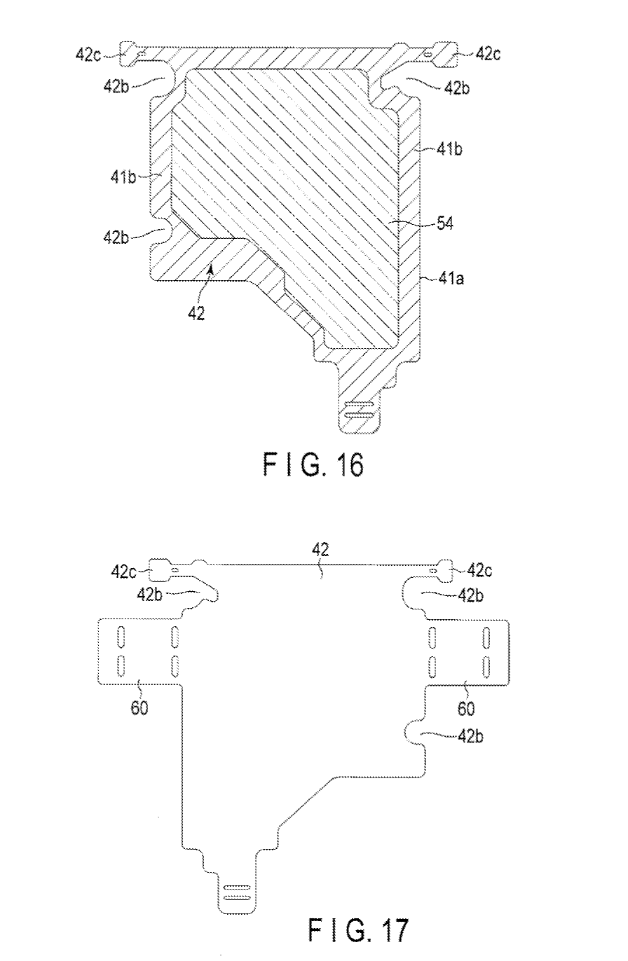

FIG. 16 shows an anti-tamper label of an HDD of the fourth embodiment. In a case where there is a region having no risk of a short circuit (in which a resist is used, only a ground signal is exposed, an insulating coating is used or the like) at the outer edges of a surface to which the anti-tamper label 42 is attached, namely, a surface of the printed circuit board 30, the anti-tamper label 42 comprises a special adhesive agent using a vapor-deposited film 41b which leaves a trace of physical tampering only on the outer edges of the label base material 41a as shown in FIG. 16. In this structure, it is possible to omit an independent sheet-shaped insulator or an insulating coating layer, and therefore a single-layer anti-tamper label 42 can be obtained.

### Fifth Embodiment

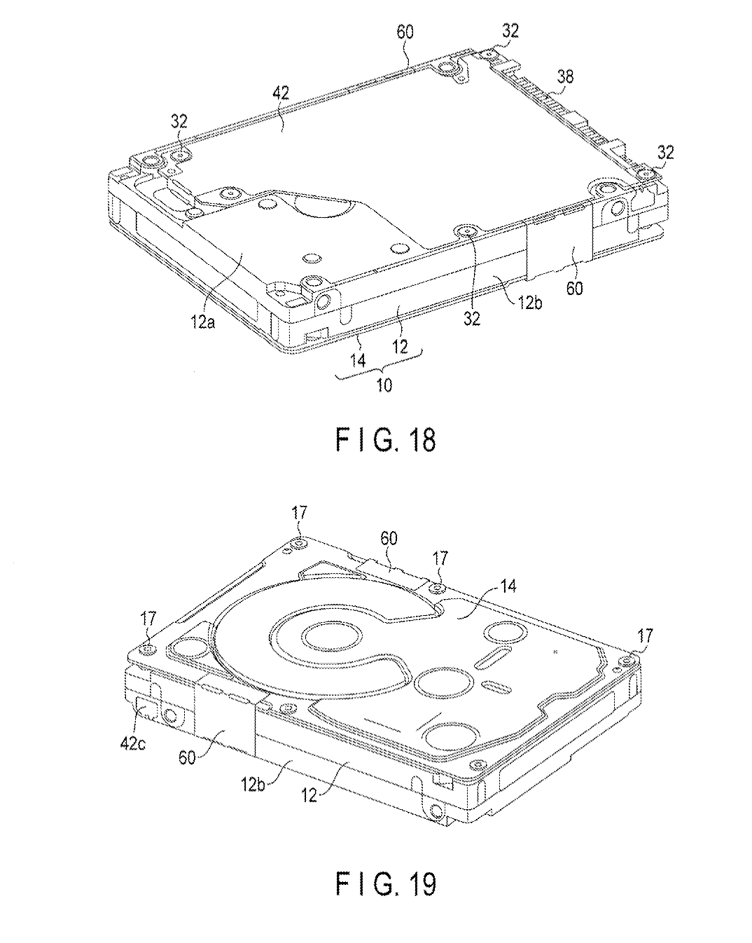

FIG. 17 is a plan view of an anti-tamper label of the fifth embodiment, and FIGS. 18 and 19 are perspective views respectively showing the bottom surface (back surface) side and the top cover side of an HDD to which the anti-tamper label is attached.

According to the present embodiment, the anti-tamper label 42 integrally comprises a pair of protruding pieces 60 having a band shape or a rectangular shape and protruding in the width direction of the label from the two side edges. On the surface of each of the protruding pieces 60, a vapor-deposited metal film and an adhesive layer are formed.

As shown in FIGS. 18 and 19, the anti-tamper label 42 is attached to the back surface 30a of the printed circuit board 30, and the pair of protruding pieces 60 is wrapped around and attached to the side walls 12a of the housing 10 and the side edges of the top cover 14.

According to the anti-tamper label 42, it is possible not only to cover the printed circuit board 30 but also to seal the base 12 of the housing 10 which accommodates magnetic disks, magnetic heads, an actuator and the like and the top cover 14.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiment described herein may be made without departing from the spirit of the invention. The accompanying claims and their equivalents are intended to cover such forms or modifications as would fall within the scope and spirit of the inventions.

The anti-tamper label is not restrictedly attached to the printed circuit board of an HDD and may be used for another device, such as an SSD, which requires the detection of the theft or possible falsification of stored data by physical tampering.

What is claimed is:

1. A storage device comprising:
a printed circuit board having a first side on which electronic components of the storage device are mounted and a second side opposite to the first side;
a label overlying the second side of the printed circuit board, the label comprising a base layer and a metal film formed on a surface of the base layer, the metal film being attached to the second side of the printed circuit board; and
an insulating layer between the second side of the printed circuit board and a portion of the label.

2. The storage device of claim 1, wherein the insulating layer has a surface area smaller than that of the label.

3. The storage device of claim 2, wherein the insulating layer is an insulating sheet.

4. The storage device of claim 3, wherein the insulating sheet has recessed portions and an opening through which the metal film is attached to the second side of the printed circuit board.

5. The storage device of claim 2, wherein the insulating layer is formed by coating a non-conductive material on the second side of the printed circuit board.

6. The storage device of claim 5, wherein the non-conductive material is a resin film.

7. The storage device of claim 2, wherein the insulating layer is formed by coating a non-conductive material on the metal film of the label.

8. The storage device of claim 7, wherein the non-conductive material is a resin film.

9. The storage device of claim 1, wherein
the label comprises an outer portion that extends beyond an outer periphery of the printed circuit board.

10. The storage device of claim 1, further comprising:
a housing for a storage medium facing the first side of the printed circuit board, wherein
the label comprises another portion that is directly attached to the housing.

11. The storage device of claim 10, wherein
said another portion of the label comprises a pair of protruding pieces extending from side edges of the label beyond the printed circuit board, and
the protruding pieces are attached to the housing.

12. The storage device of claim 11, wherein
the housing comprises a base and a top cover fixed to the base, and
the protruding pieces are attached to the top cover.

13. A storage device comprising:
a printed circuit board having a first side on which components of the storage device are mounted and a second side opposite to the first side; and
a label overlying the second side of the printed circuit board, the label comprising a base layer and a metal film formed on a portion of the base layer so that the metal film overlies and is attached to a first portion of the printed circuit board and the base layer overlies a second portion of the printed circuit board.

14. The storage device of claim 13, wherein the metal film is formed on an outer peripheral region of the base layer.

15. The storage device of claim 13, wherein the first portion of the printed circuit board includes non-conductive portions of the printed circuit board and conductive portions the printed circuit board that do not cause a short circuit.

16. The storage device of claim 13, wherein
the label comprises an outer portion that extends beyond an outer periphery of the printed circuit board.

17. The storage device of claim 13, further comprising:
a housing for a storage medium facing the first side of the printed circuit board, wherein
the label comprises another portion that is directly attached to the housing.

18. The storage device of claim 17, wherein
said another portion of the label comprises a pair of protruding pieces extending from side edges of the label beyond the printed circuit board, and
the protruding pieces are attached to the housing.

19. The storage device of claim 18, wherein
the housing comprises a base and a top cover fixed to the base, and
the protruding pieces are attached to the top cover.

20. A method of applying an anti-tamper label onto a storage device including a printed circuit board, which has a first side on which components of the storage device are mounted and a second side opposite to the first side, said method comprising:
attaching a label on the second side of the printed circuit board, the label comprising a base layer and a metal film formed on a portion of the base layer so that the metal film overlies and is attached to a first portion of the printed circuit board via an adhesive and the base layer overlies a second portion of the printed circuit board,
wherein the first portion of the printed circuit board is non-conductive and the adhesive leaves a trace on the printed circuit board when the label is removed from the printed circuit board.
